(19) United States
(12) Patent Application Publication
(10) Pub. No.: US 2013/0301445 A1
(43) Pub. Date: Nov. 14, 2013

(54) RADIO BASE STATION, USER TERMINAL AND RADIO COMMUNICATION METHOD

(71) Applicants: Tetsushi Abe, Tokyo (JP); Mikio Iwamura, Tokyo (JP); Nobuniko Miki, Tokyo (JP); Hideaki Takahashi, Tokyo (JP)

(72) Inventors: Tetsushi Abe, Tokyo (JP); Mikio Iwamura, Tokyo (JP); Nobuniko Miki, Tokyo (JP); Hideaki Takahashi, Tokyo (JP)

(73) Assignee: NTT DOCOMO, INC., Tokyo (JP)

(21) Appl. No.: 13/885,238

(22) PCT Filed: Nov. 10, 2011
(86) PCT No.: PCT/JP2011/075917

§ 371 Date: Jul. 29, 2013

(30) Foreign Application Priority Data
Nov. 15, 2010 (JP) 2010-255304

(51) Int. Cl. H04W 24/10

(52) U.S. Cl. CPC H04W 24/10
USPC 370/252

(57) ABSTRACT

Provided are a radio base station, a user terminal and a radio communication method capable of making accurate measurement in various network configurations in HetNet. The radio communication method according to the present invention has, in a heterogeneous network having a network configuration where a macro cell overlays a micro cell that is smaller than the macro cell, a radio base station that forms the macro cell and is connected to a macro terminal under control of the macro cell determining a measurement subframe to measure a CRS based on the network configuration, generating a time reference indicating the measurement subframe and transmitting a signal including the time reference and the CRS to the macro terminal; and the macro terminal receiving the time reference and the CRS and measuring the CRS in the measurement subframe indicated by the time reference.

### TECHNICAL FIELD

The present invention relates to a radio base station, a user terminal and a radio communication method in a radio communication system where a micro cell is provided in a macro cell.

### BACKGROUND ART

There has been defined in the standards organization 3GPP a radio communication system employing an LTE (Long Term Evolution) scheme (hereinafter referred to as “LTE system”) as a successor system to the UMTS (Universal Mobile Telecommunications System). Now in 3GPP, a radio communication system employing an LTE-Advanced scheme (hereinafter referred to as “LTE-A system”) has been under study as a successor system to the LTE system.

In the LTE-A system, there has been studied HetNet (Heterogeneous Network) in which a micro cell (for example, pico cell or femto cell) having a local coverage of about several-ten-meter radius is formed in a macro cell having a wide coverage of several-kilometer radius (for example, see Non Patent Literature 1).

In such HetNet, for the purpose of improving throughput of the whole system, it has been studied to perform CRE (Cell Range Expansion). In CRE, the range of the micro cell is expanded by adding an offset to reception power from a radio base station that forms the micro cell (hereinafter referred to as “micro base station”). Therefore, a user terminal positioned inside the expanded micro cell can be handed over from a radio base station that forms the macro cell (hereinafter referred to as “macro base station”) to the micro base station. Use of such CRE is considered to make the macro UE under control of the macro base station be handed over to the micro cell for offloading, thereby increasing the network capacity.

Considering this handover of the macro UE to the micro cell, the macro UE handed over to the micro base station suffers from large interference from the macro base station and cannot measure quality of the micro base station. Therefore, interference coordination has been under study to stop data transmission by the macro base station in some subframes thereby to reduce interference that the macro UE suffers from by the macro base station.

FIG. 1 is a diagram illustrating an example of interference coordination. As illustrated in FIG. 1, in subframes in which the macro base station performs data transmission (first and third subframes from the left), reception power of the macro UE from the micro base station is lowered because it suffers from interference from the macro base station. On the other hand, in subframes where the macro base station stops data transmission (second and fourth subframes from the left), reception power of the macro UE from the micro base station is increased because it does not suffer from interference from the macro base station. Here, in subframes where the data transmission is stopped (hereinafter referred to as “transmission stopped subframes), data transmission may not be stopped completely or a small amount of data may be transmitted as far as interference to the user terminal falls within acceptable limits. As a transmission stopped subframe, for example, a MBSFN (MBMS (Multimedia Broadcast and Multicast Service) over a Single Frequency Network) subframe or an ABS (Almost Blank Subframe) may be used.

With such interference coordination, the user terminal can make quality measurement of the micro base station in transmission stopped subframes of the macro base station, and thereby the user terminal can be handed over from the macro base station to the micro base station. In this case, the macro base station notifies the user terminal of a measurement pattern indicating which subframe to use for measurement.

When thus notifying the user terminal of the measurement pattern, if the measurement pattern is for an individual cell, there is an increase in parameters of which the macro base station notifies the user terminal. Accordingly, it has been studied to notify the user terminal of two measurement patterns including one for one serving cell and the other for all neighbor cells. For example, the macro UE illustrated in FIG. 2A receives notification of one pattern for the macro cell and one common pattern for the pico cell (adjacent cell to the macro cell MC) and adjacent cells to the macro cell (not shown).

### CITATION LIST

### Non-Patent Literature

Non-Patent Literature 1: 3GPP, TS36.300

### SUMMARY OF THE INVENTION

### Technical Problem

In the above-described HetNet, such a network configuration that the macro cell overlays the micro cell is employed. The micro cells include an OSG-cell (pico cell) and a CSG cell (femto cell). For example, in the network configuration illustrated in FIG. 2A described later, if the macro UE is handed over to the micro cell (pico cell), the macro base station becomes an interference source for the macro UE, and it is necessary to apply interference coordination to signals from the macro base station (macro subframes). On the other hand, in the network configuration illustrated in FIG. 4A described later, if the macro UE is handed over to the micro cell (femto cell), the macro base station becomes an interference source for the macro UE and it is necessary to apply interference coordination to signals from the femto base station (femto subframes).

In this way, as the interference source for the macro UE depends on the network configuration, more specifically, the type of a micro cell, there is need to change a target to which the interference coordination applies, as appropriate. However, there is considered to be a problem that it is difficult to make accurate measurement of some network configurations only by communicating the two measurement patterns as described above.

The present invention was carried out in view of the foregoing and aims to provide a radio base station, a user terminal and a radio communication method capable of making accurate measurement even of various network configurations in HetNet.

### Solution to Problem

The present invention provides a radio base station in a heterogeneous network having a network configuration where a macro cell overlays a micro cell that is smaller than the macro cell, the radio base station comprising: a subframe determining section configured to generate a measurement subframe pattern to measure a channel state and a time reference indicating a pattern start timing of the measurement subframe pattern based on the network configuration; and a transmitting section configured to transmit a signal including the measurement subframe pattern and the time reference to a user terminal.

The present invention provides a user terminal in a heterogeneous network having a network configuration where a macro cell overlays a micro cell that is smaller than the macro cell, the user terminal comprising: a receiving section configured to receive a measurement subframe pattern to measure a channel state; and a measuring section configured to measure the channel state in accordance with the measurement subframe pattern and a time reference indicating a pattern start timing.

The present invention provides a radio communication method comprising the steps of: a radio base station in a heterogeneous network having a network configuration where a macro cell overlays a micro cell that is smaller than the macro cell, generating a measurement subframe pattern to measure a channel state and a time reference indicating a pattern start timing of the measurement subframe pattern based on the network configuration; and transmitting a signal including the measurement subframe pattern and the time reference to a user terminal; and the user terminal receiving the signal including the measurement subframe pattern and the time reference; and measuring the channel state based on the measurement subframe pattern and the time reference.

The present invention provides a radio communication method comprising the steps of: a radio base station in a heterogeneous network having a network configuration where a macro cell overlays a micro cell that is smaller than the macro cell, generating a measurement subframe pattern to measure a channel state based on the network configuration; and transmitting a signal including the measurement subframe pattern to a user terminal; and the user terminal receiving the signal including the measurement subframe pattern; and measuring the channel state based on the measurement subframe pattern and a time reference indicating a pattern start timing of the measurement subframe pattern.

### Technical Advantage of the Invention

According to the present invention, the radio base station in HetNet generates a measurement subframe pattern to measure a channel state based on a network configuration and a user terminal measures the channel state with the measurement subframe pattern and a time reference indicating the pattern start timing. The time reference includes timing information for the user terminal to be able to make accurate measurement in accordance with the network configuration. Therefore, it is possible to make accurate measurement even of various network configurations.

### BRIEF DESCRIPTION OF THE DRAWINGS

FIG. 1 is a diagram illustrating an example of interference coordination;

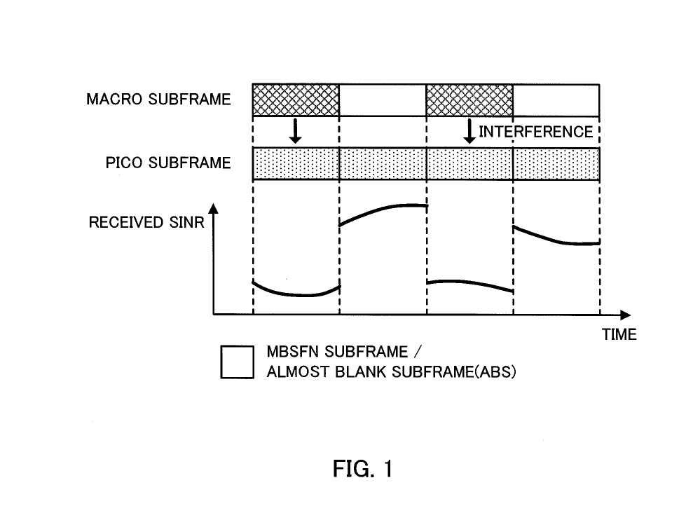

FIG. 2A is a diagram schematically illustrating the configuration of a radio communication system to which a radio communication method according to an embodiment 1 of the present invention is applied, and FIG. 2B is a diagram illustrating a subframe pattern when the interference coordination is applied;

FIGS. 3A and 3B are diagrams illustrating measurement patterns in the radio communication method according to the embodiment 1 of the present invention;

FIG. 4A is a diagram schematically illustrating the configuration of a radio communication system to which a radio communication method according to an embodiment 2 of the present invention is applied, and FIG. 4B is a diagram illustrating a subframe pattern when the interference coordination is applied;

FIGS. 5A and 5B are diagrams illustrating measurement patterns in the radio communication method according to the embodiment 2 of the present invention;

FIG. 6 is a functional diagram of a radio base station (macro base station) according to an embodiment of the present invention;

FIG. 7 is a functional diagram of a radio base station (neighbor base station) according to an embodiment of the present invention; and

FIG. 8 is a functional diagram of a user terminal (macro UE) according to an embodiment of the present invention.

### DESCRIPTION OF EMBODIMENTS

### Embodiment 1

In this embodiment, it is assumed that in the HetNet having a network configuration where a macro cell overlays a micro cell that is smaller than the macro cell, the micro cell is an OSG (Open Subscriber Group) cell (pico cell).

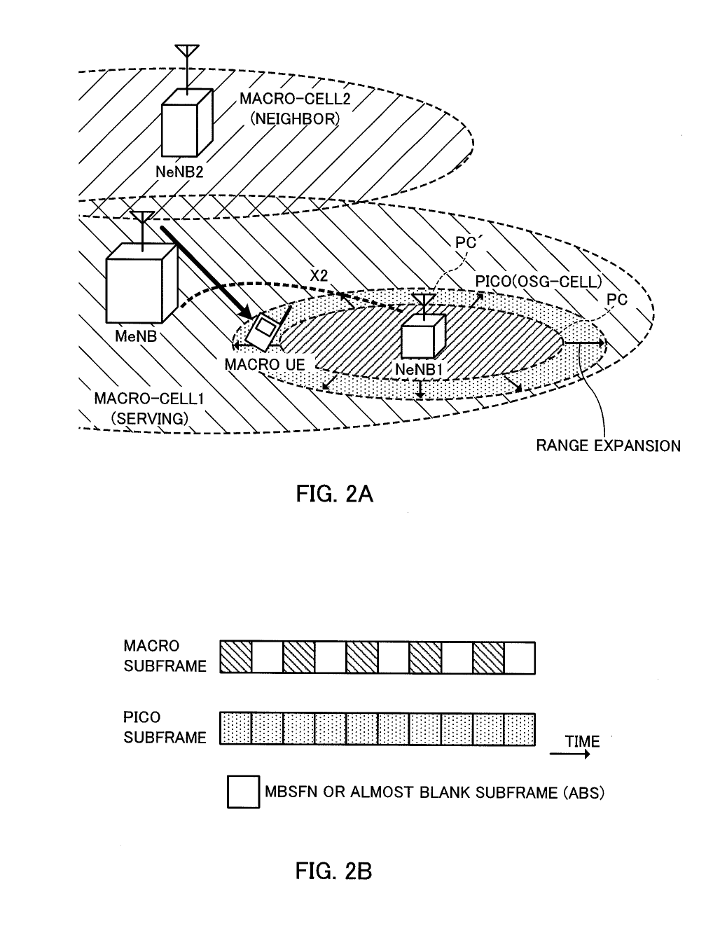

FIG. 2A is a schematic diagram illustrating the configuration of a radio communication system to which a radio communication method according to the embodiment 1 of the present invention is applied, and FIG. 2B is a diagram illustrating a subframe pattern when the interference coordination is applied.

In the radio communication system illustrated in FIG. 2A, the macro cell 1 overlays the micro cell (pico cell) as a neighbor cell to the macro cell. And, there exists a macro cell 2 as a neighbor cell to the macro cell 1. The macro cell 1 is a cell formed by a radio base station (macro base station) MeNB, the pico cell as a neighbor cell is a cell formed by a radio base station (neighbor base station:pico base station) NeNB1, and the macro cell 1 is a cell formed by a radio base station of the macro cell 2 as a neighbor cell (neighbor base station:macro base station) NeNB2. Here, it is assumed that the user terminal UE (macro UE) is connected to the macro base station (serving cell) MeNB.

As illustrated in FIG. 2A, the macro base station MeNB and the pico base station NeNB1 are connected to each other by a wired X2 interface. And, the macro base station MeNB and the pico base station NeNB1 are connected to a core network (not shown), respectively. And, the macro base station MeNB and the pico base station NeNB1 cover at least a part of a radio frequency band in a shared manner. In the radio communication system illustrated in FIG. 2, the macro UE is located outside the pico cell PC. Therefore, reception power of the macro UE from the macro base station MeNB becomes larger than reception power from the pico base station NeNB1, and it is connected to the macro base station MeNB.

In the radio communication system illustrated in FIG. 2A, CRE (Cell Range Expansion) is conducted. In CRE, as an offset is applied to the reception power from the pico base station NeNB1, if the macro UE is positioned outside the pico cell PC but inside the expanded pico cell PC′, the reception power of the macro UE from the pico base station NeNB1 (added with the offset) becomes larger than the reception power from the macro base station MeNB. Therefore, when it is positioned outside the pico cell PC but inside the expanded pico cell PC′, the macro UE can be connected to the pico base station NeNB1 and handed over from the macro base station MeNB to the pico base station NeNB1.

When the macro UE is handed over from the macro base station MeNB to the pico base station NeNB1, it is necessary to measure the quality of the macro base station MeNB and the quality of the pico base station NeNB1. However, when the macro UE is located at the position illustrated in FIG. 2A, signals from the macro base station MeNB become interference so that it cannot measure the quality of the pico base station NeNB1. Therefore, as illustrated in FIG. 2B, interference coordination is applied to make some of subframes in the macro base station transmission stopped subframes. In the example illustrated in FIG. 2B, even-numbered subframes from the left are transmission stopped subframes.

Here, the transmission stopped subframes used here include, for example, a MBSFN subframe and an ABS. The ABS is a subframe in which a CRS (Common Reference Signal) is only transmitted and data is not transmitted in a data channel. On the other hand, the MBSFN subframe is a subframe in which neither a CRS nor data is transmitted in the data channel. Thus, as no CRS is transmitted in the data channel, the MBSFN subframe is advantageous as it can reduce the interference due to CRS as compared to the ABS. Note that in the MBSFN subframe, the CRS is transmitted in the control channel.

As described above, when conducting interference coordination, the macro base station notifies the macro UE of a measurement pattern for CRS measurement. In this embodiment, as the macro base station becomes an interference source for the macro UE, transmission stopped subframes are set in subframes of the macro base station (macro subframes). That is, as illustrated in FIG. 2B, one measurement subframe pattern is a macro subframe pattern including transmission stopped subframes and the other measurement subframe pattern is a pico subframe pattern including no transmission stopped subframe (CRS may be measured in any subframe).

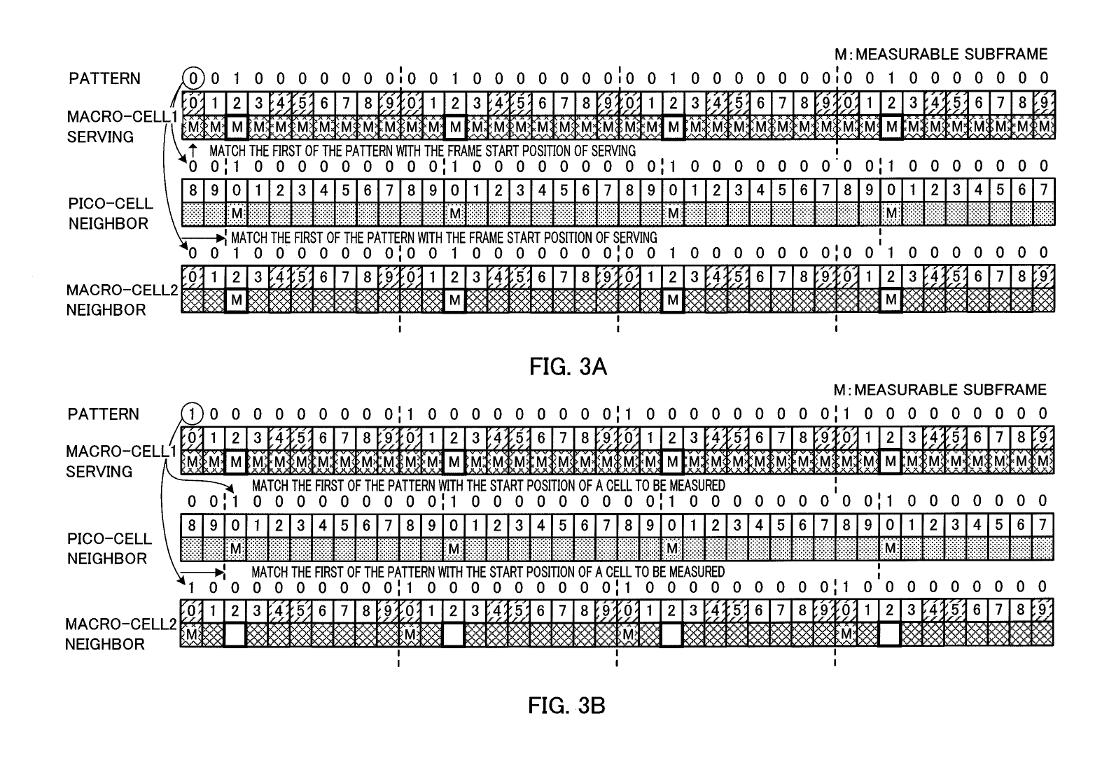

Next description is made specifically about a method of determining a measurement subframe pattern. FIGS. 3A and 3B are diagrams illustrating measurement subframe patterns in the radio communication method according to the embodiment 1 of the present invention.

In the first method according to the present embodiment, the macro base station MeNB notifies the macro UE of a time reference indicating to match a pattern start timing with a radio frame timing of a radio base station (Macro-Cell Serving) which has transmitted the measurement subframe pattern.

The measurement subframe pattern illustrated in FIG. 3A is formed with four radio frames, one radio frame having subframes #0 to #9. In this measurement subframe pattern, the subframes #2 are transmission stopped subframes. The measurement subframe pattern illustrated in FIG. 3A is, specifically, a pattern of “0010000000 0010000000 0010000000 001000000”. In this pattern, “1” indicates a subframe in which the CRC is measurable. This subframe pattern is determined by the macro base station MeNB as a radio base station. In this case, the measurement subframe pattern for CRS measurement is determined based on the network configuration, that is, the network configuration in which the macro cell overlays the pico cell. This measurement subframe pattern is communicated from the macro base station MeNB to the macro UE.

In addition to the measurement subframe pattern, the macro base station MeNB notifies the macro UE of a time reference indicating a pattern start timing of the measurement subframe pattern. With this notification, the user terminal can determine the measurement timing of the measurement subframe pattern thereby to be able to make accurate measurement.

The pico base station NeNB1 as a neighbor base station shifts subframes based on a shift amount communicated from the macro base station MeNB. In FIG. 3A, the pico base station NeNB1 shifts the subframes by two in accordance with the shift amount communicated from the macro base station MeNB. With this structure, the subframe #0 in the pico base station NeNB1 is matched with the subframe #2 in the macro base station MeNB.

The pico base station NeNB1 performs transmission to the macro UE at the timing of Pico-cell Neighbor in FIG. 3A. As the macro UE has received the time reference indicating to match the pattern start timing with the radio frame timing of the radio base station (Macro-cell 1 Serving) having transmitted the measurement subframe pattern, the macro UE determines the measurement timing based on this time reference and makes measurement. In other words, in FIG. 3A, the first of the measurement subframe pattern is matched with the start position of the radio frame (subframe #8 of the Pico-cell Neighbor corresponding to the subframe #0 of the Macro-cell 1 Serving) of the radio base station (Macro cell 1 Serving) having transmitted the measurement subframe pattern.

The radio base station (macro base station) NeNB2 of a neighbor cell performs transmission to the macro UE at the timing of Macro-cell 1 Neighbor in FIG. 3A. As the macro UE has received the time reference indicating to match the pattern start timing with the radio frame timing of the radio base station (Macro-cell 1 Serving) having transmitted the measurement subframe pattern, the macro UE determines the measurement timing based on this time reference and makes measurement. In other words, in FIG. 3A, the first of the measurement subframe pattern is matched with the start position of the radio frame (subframe #0 of Macro-cell 2 Neighbor corresponding to the subframe #0 of Macro-cell 1 Serving) of the radio base station (Macro-cell 1 Serving) having transmitted the measurement subframe pattern.

In this way, as the measurement subframe pattern for the macro UE to measure the CRS and time reference indicating the pattern start timing are generated based on the network configuration illustrated in FIG. 3A and transmitted to the macro UE and the macro UE determines the measurement timing based on the measurement subframe pattern, the time reference and the shift amount and measures a channel state, the macro UE can make accurate measurement of the pico cell.

In this first method, when the radio base station (macro base station) NeNB2 of the neighbor cell and the macro base station MeNB are in synchronization and they both use MBSFN subframes as transmission stopped subframes (Macro-cell 2 Neighbor in FIG. 3A), the neighbor base station (macro base station) NeNB2 can make measurement in MBSFN subframes only at the timing of transmission stopped subframes of the macro base station MeNB (timing of the subframe #2). In this case, as described above, in each MBSFN subframe, as the CRS is only contained in the control channel, there may be deterioration of quality measurement accuracy.

Then, in a second method in the present embodiment, the macro base station MeNB notifies the macro UE of a time reference indicating to match the pattern start timing with a radio frame timing of each cell as a measurement target.

The measurement subframe pattern illustrated in FIG. 3B is formed with four radio frames, one radio frame including subframes #0 to #9. In this measurement subframe pattern, subframes #0 are transmission stopped subframes. The measurement subframe pattern illustrated in FIG. 3B is a pattern of “1000000000 1000000000 1000000000 1000000000”. In this pattern, indicates a subframe in which the CRC is measurable. This subframe pattern is determined by the macro base station MeNB as a radio base station. In this case, the measurement subframe pattern for CRS measurement is determined based on the network configuration, that is, network configuration in which the macro cell overlays the pico cell. This measurement subframe pattern is communicated from the macro base station MeNB to the macro UE.

The pico base station NeNB1 as a neighbor base station shifts subframes based on a shift amount communicated from the macro base station MeNB. In FIG. 3B, the pico base station NeNB1 shifts the subframes by two in accordance with the shift amount communicated from the macro base station MeNB. With this structure, the subframes #0 in the pico base station NeNB1 are matched with the subframes #2 in the macro base station MeNB.

The pico base station NeNB1 performs transmission to the macro UE at the timing of Pico-cell neighbor in FIG. 3B. As the macro UE has received the time reference indicating to match the pattern start timing with the radio frame timing of each cell as a measurement target, the macro UE determines the measurement timing based on this time reference and performs measurement. That is, in FIG. 3B, the first of the measurement subframe pattern is matched with the start position of the radio frame of Pico-cell Neighbor (subframe #0 of Pico-cell Neighbor). In this case, the transmission stopped subframes of Macro-cell 1 Serving (subframes #2) are matched with the subframes #0 of Pico-cell Neighbor (measurable subframes).

The radio base station (macro base station) NeNB2 of the neighbor cell performs transmission to the macro UE at the timing of Macro-cell 2 Neighbor in FIG. 3B. As the macro UE has received the time reference indicating to match the pattern start timing with the radio frame timing of each cell as a measurement target, the macro UE determines the measurement timing based on this time reference and performs measurement. That is, in FIG. 3B, the start of the measurement subframe pattern is matched with the start position of radio frame of the Macro-cell 2 Neighbor (subframe #0 of Macro-cell 2 Neighbor).

In this way, as the measurement subframe pattern for the macro UE to measure the CRS and the time reference indicating the pattern start timing are generated based on the network configuration illustrated in FIG. 3B and transmitted to the macro UE and the macro UE determines the measurement timing based on the measurement subframe pattern, the time reference and the shift amount and measures the channel state, the macro UE is able to make accurate measurement of the pico cell. Note, in this case, even when the radio base station (macro base station) NeNB2 of the neighbor cell and the macro base station MeNB are in synchronization and they both use MBSFN subframes as transmission stopped subframes (Macro-cell 2 Neighbor in FIG. 3B), the neighbor base station (macro base station) NeNB2 makes measurement at the timing of subframes different from the transmission stopped subframes of the macro base station MeNB (time of subframes #0), which can prevent deterioration of quality measurement accuracy. Therefore, when the micro cell is an OSG cell, the second method is preferably applied.

### Embodiment 2

In this embodiment, it is assumed that in the HetNet having a network configuration where a macro cell overlays a micro cell that is smaller than the macro cell, the micro cell is a CSG (Closed Subscriber Group) cell (femto cell).

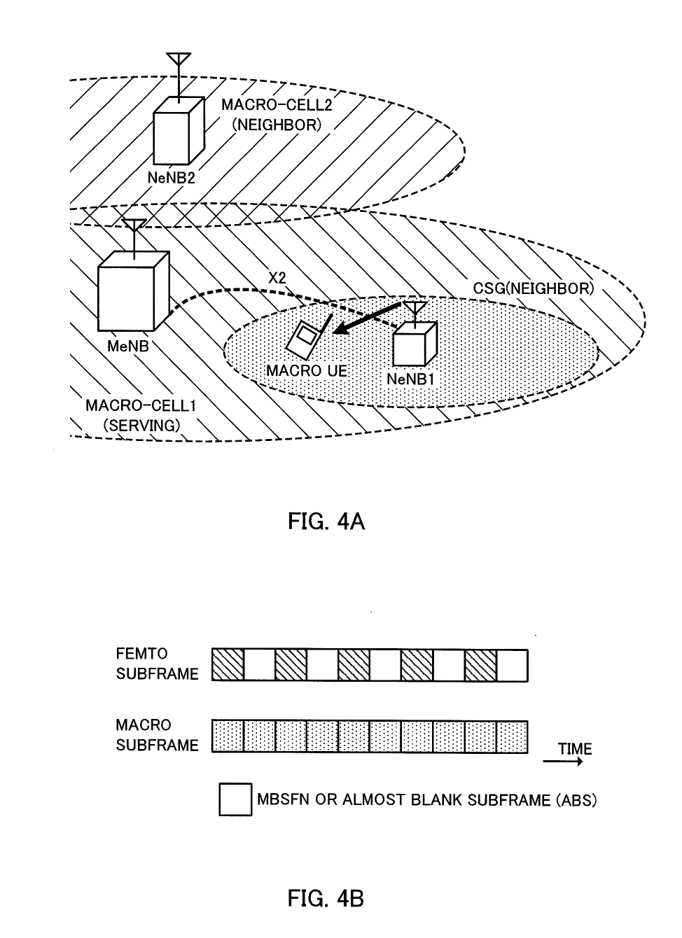

FIG. 4A is a schematic diagram illustrating the configuration of a radio communication system to which a radio communication method according to the embodiment 2 of the present invention is applied, and FIG. 4B is a diagram illustrating a subframe pattern when the interference coordination is applied.

In the radio communication system illustrated in FIG. 4A, the macro cell 1 overlays the micro cell (femto cell) as a neighbor cell to the macro cell. And, there exists a macro cell 2 as a neighbor cell to the macro cell 1. The macro cell 1 is a cell formed by a radio base station (macro base station) MeNB, a pico cell as a neighbor cell is a cell formed by a radio base station (adjacent base station:femto base station) NeNB1, and the macro cell 1 is a cell formed by a radio base station of the macro cell 2 as a neighbor cell (adjacent base station:macro base station) NeNB2. Here, it is assumed that the user terminal UE (macro UE) is connected to the macro base station (serving cell) MeNB.

As illustrated in FIG. 4A, the macro base station MeNB and the femto base station NeNB1 are connected to a core network (not shown), respectively. The femto cell is a cell to which a user terminal of a non-member (non-subscriber) cannot be connected. If a non-member macro UE exists within the femto cell, the macro UE suffers from heavy interference from the femto base station NeNB1. Note that a shift amount described later will be a fixed amount and is input in advance to the femto base station.

When the macro UE is handed over from the macro base station MeNB to the femto base station NeNB1, it is necessary to measure the quality of the macro base station MeNB and the quality of the femto base station NeNB1. However, when the macro UE is located at the position illustrated in FIG. 4A, signals from the femto base station NeNB1 become heavy interference so that it cannot measure the quality of the macro base station MeNB. Therefore, as illustrated in FIG. 4B, interference coordination is applied to make some of subframes in the femto base station transmission stopped subframes. In the example illustrated in FIG. 4B, even-numbered subframes from the left are transmission stopped subframes.

Here, the transmission stopped subframes used here include, for example, a MBSFN subframe and an ABS. The ABS is a subframe in which a CRS (Common Reference Signal) is only transmitted and data is not transmitted in a data channel. On the other hand, the MBSFN subframe is a subframe in which neither a CRS nor data is transmitted in the data channel. Thus, as no CRS is transmitted in the data channel of the MBSFN subframe, the MBSFN subframe is advantageous as it can reduce the interference due to CRS as compared to the ABS. Note that in the MBSFN subframe, the CRS is transmitted in the control channel.

As described above, when conducting interference coordination, the macro base station notifies the macro UE of a measurement pattern for CRS measurement. In this embodiment, as the femto base station becomes an interference source for the macro UE, transmission stopped subframes are set in subframes of the femto base station (femto subframes). That is, as illustrated in FIG. 4B, one measurement subframe pattern is a femto subframe pattern including transmission stopped subframes and the other measurement subframe pattern is a macro subframe pattern including no transmission stopped subframe (CRS may be measured in any subframe).

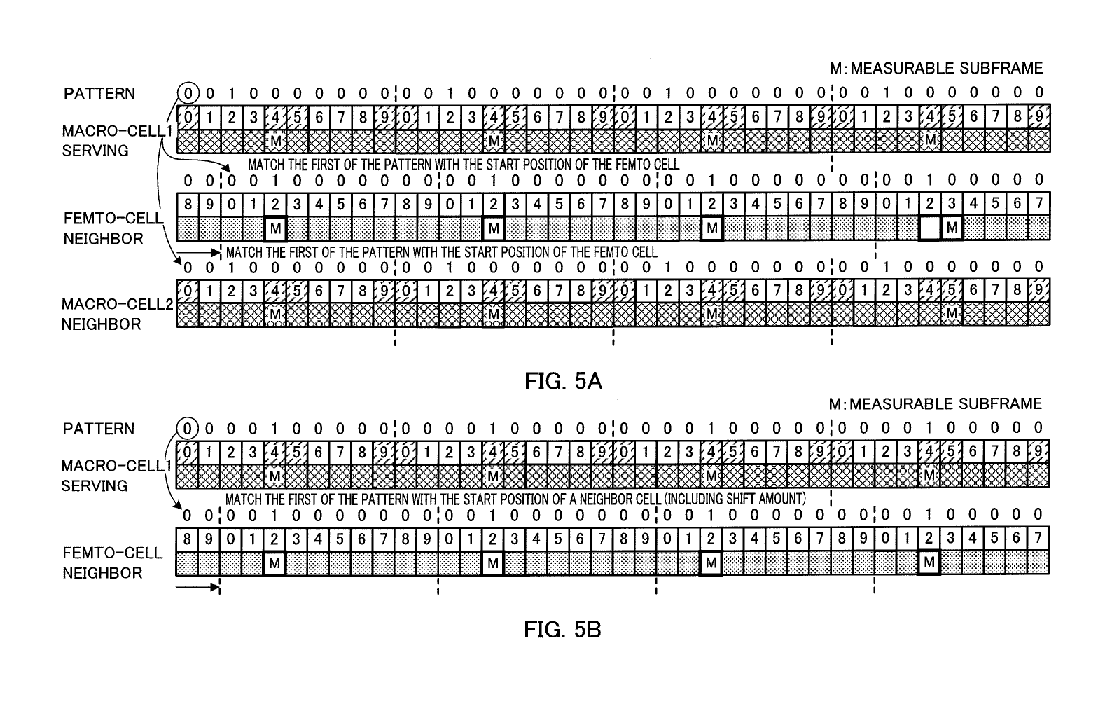

Next description is made specifically about a method of determining a measurement subframe pattern. FIGS. 5A and 5B are diagrams illustrating measurement subframe patterns in the radio communication method according to the embodiment 2 of the present invention.

In the first method according to the present embodiment, the macro base station MeNB notifies the macro UE of a time reference indicating to match a pattern start timing with a radio frame timing of a femto cell as a measurement target.

The measurement subframe pattern illustrated in FIG. 5A is formed with four radio frames, one radio frame having subframes #0 to #9. In this measurement subframe pattern, the subframes #4 are transmission stopped subframes. The measurement subframe pattern illustrated in FIG. 5A is, specifically, a pattern of “0010000000 0010000000 0010000000 001000000”. In this pattern, “1” indicates a subframe in which the CRS is measurable. This subframe pattern is determined by the macro base station MeNB as a radio base station. In this case, the measurement subframe pattern for CRS measurement is determined based on the network configuration, that is, the network configuration in which the macro cell overlays the femto cell. This measurement subframe pattern is communicated from the macro base station MeNB to the macro UE.

The femto base station NeNB1 as a neighbor base station shifts subframes based on a shift amount communicated from the macro base station MeNB. In FIG. 5A, the femto base station NeNB1 shifts the subframes by two in accordance with the shift amount communicated from the macro base station MeNB. With this structure, the subframes #4 in the femto base station NeNB1 are matched with the subframes #2 in the macro base station MeNB.

The femto base station NeNB1 performs transmission to the macro UE at the timing of Femto-cell Neighbor in FIG. 5A. As the macro UE has received the time reference indicating to match the pattern start timing with the radio frame timing of the femto cell as a measurement target, the macro UE determines the measurement timing based on this time reference and makes measurement. In other words, in FIG. 5A, the first of the measurement subframe pattern is matched with the start position of the radio frame of Femto-cell Neighbor (subframe #0 of Femto-cell Neighbor). In this case, the transmission stopped subframes of Macro-cell 1 Serving (subframes #4) are matched with the subframes #2 of Femto-cell Neighbor (measurable subframes).

The radio base station (macro base station) NeNB2 of a neighbor cell performs transmission to the macro UE at the timing of Macro-cell 2 Neighbor in FIG. 5A. As the macro UE has received the time reference indicating to match the pattern start timing with the radio frame timing of the femto cell as a measurement target, the macro UE determines the measurement timing based on this time reference and makes measurement. In other words, in FIG. 5A, the first of the measurement subframe pattern is matched with the start position of the radio frame of Macro-cell 2 Neighbor (subframe #0 of Macro-cell 2 Neighbor).

In this way, as the measurement subframe pattern for the macro UE to measure the CRS and the time reference indicating the pattern start timing are generated based on the network configuration illustrated in FIG. 5A and transmitted to the macro UE, and the macro UE determines the measurement timing based on the measurement subframe pattern, the time reference and the shift amount and measures the channel state, the macro UE is able to make accurate measurement of the pico cell. Note, in this case, the same measurement subframe pattern is used for the radio base station (macro base station) NeNB2 of a neighbor cell (Macro-cell 2 Neighbor in FIG. 5A). With this structure, the macro UE is able to make accurate measurement of the femto cell and neighbor cell (macro cell 2). Therefore, when the micro cell is a CSG cell, the first method is preferably applied.

Then, in a second method in the present embodiment, the macro base station MeNB notifies the macro UE of a time reference indicating to match the pattern start timing with a radio frame timing of each cell as a measurement target.

The measurement subframe pattern illustrated in FIG. 5B is formed with four radio frames, one radio frame including subframes #0 to #9. In this measurement subframe pattern, subframes #4 are transmission stopped subframes. The measurement subframe pattern illustrated in FIG. 5B is, specifically, a pattern of “0000100000 0000100000 0000100000 0000100000”. In this pattern, “1” indicates a subframe in which the CRC is measurable. This subframe pattern is determined by the macro base station MeNB as a radio base station. In this case, the measurement subframe pattern for CRS measurement is determined based on the network configuration, that is, network configuration in which the macro cell overlays the femto cell. This measurement subframe pattern is communicated from the macro base station MeNB to the macro UE.

The femto base station NeNB1 as a neighbor base station shifts subframes based on a shift amount communicated from the macro base station MeNB. In FIG. 5B, the femto base station NeNB1 shifts the subframes by two in accordance with the shift amount communicated from the macro base station MeNB. With this structure, the subframes #4 in the femto base station NeNB1 are matched with the subframes #2 in the macro base station MeNB.

The femto base station NeNB1 performs transmission to the macro UE at the timing of Femto-cell Neighbor in FIG. 5B. As the macro UE has received the time reference indicating to match the pattern start timing with the radio frame timing of each cell as a measurement target, the macro UE determines the measurement timing based on this time reference and performs measurement. That is, in FIG. 5B, the first of the measurement subframe pattern is matched with the start position of the radio frame of Femto-cell Neighbor (subframes #8 of Femto-cell Neighbor). In this case, the transmission stopped subframes of Macro-cell 1 Serving (subframes #4) are matched with the subframes #2 of Femto-cell Neighbor (measurable subframes).

In this way, as the measurement subframe pattern for the macro UE to measure the CRS and the time reference indicating the pattern start timing are generated based on the network configuration illustrated in FIG. 5B and transmitted to the macro UE and the macro UE determines the measurement timing based on the measurement subframe pattern, the time reference and the shift amount and measures the channel state, the macro UE is able to make accurate measurement of the pico cell.

Note in the embodiments 1 and 2, if the neighbor base station (macro base station) NeNB2 is not in synchronization with the macro base station MeNB, the indicated timing may not be matched with the first of the subframes of the neighbor cell (Macro-cell 2 Neighbor) when the macro UE makes measurement of the neighbor cell. In such a case, when making measurement of the neighbor cell, the macro UE may make measurement of also subframes adjacent to the measurement subframes and correct the measured values thereby to use them as quality measurement values. For example, the quality measurement value used here may be an average between a measured value of a measurement subframe and a measured value of an adjacent subframe, or either better value between them.

In the above-described embodiments 1 and 2, the radio base station notifies the user terminal of a measurement subframe pattern and a time reference together and the user terminal determines a measurement timing based on the measurement subframe pattern and the time reference and makes measurement. However, this structure is by no means intended to limit the present invention and the user terminal may use a predetermined time reference to determine a measurement timing and make measurement. In such a case, the radio base station notifies the user terminal of the measurement subframe pattern only. It can be switched as appropriate in accordance with the network configuration whether the time reference is communicated from a radio base station or the time reference is held by the user terminal.

In this way, according to the present invention, the radio base station notifies the user terminal of a measurement subframe pattern to measure a channel state and the user terminal having received the measurement subframe pattern determines a measurement timing of each cell with use of the time reference and makes measurement. Note the time reference is one indicating a pattern start timing of the measurement subframe pattern, and more specifically, it indicates (1) to match the pattern start timing with a radio frame timing of a radio base station having transmitted the measurement subframe pattern or (2) to match the pattern start timing with a radio frame timing of a cell as a measurement target.

Next description is made about a radio base station and a user terminal to which a radio communication method according to an embodiment of the present invention is applied. The rough structure of a radio communication system according to the embodiment of the present invention is the same as that illustrated in FIG. 2. Each apparatus illustrated in FIGS. 2A and 4A (that is, a macro base station MeNB, a pico base station (femto base station) NeNB1 and a macro UE) has hardware such as an antenna, a communication interface, a processor, a memory and a transmission/reception circuit and the memory stores software modules to be executed by the processor. And, the functional structure of each apparatus described later may be realized by the above-described hardware, by software modules executed by the processor, or may be realized in their combination.

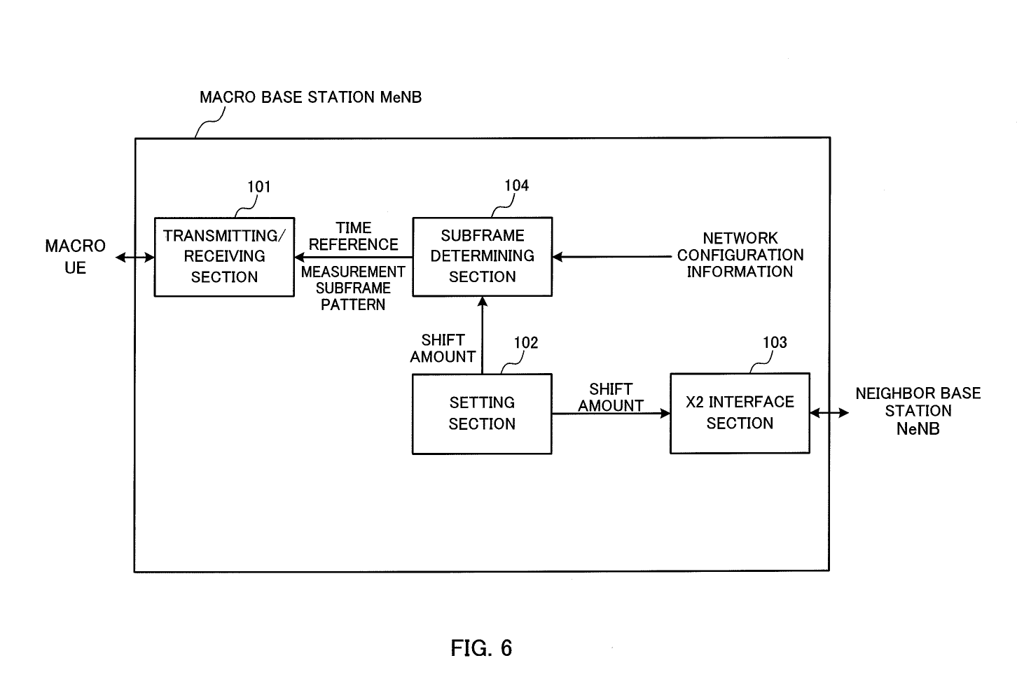

FIG. 6 is a diagram illustrating the functional structure of the macro base station MeNB according to the embodiment of the present invention. As illustrated in FIG. 6, the macro base station MeNB has a transmitting/receiving section 101, a setting section 102, an X2 interface section 103 and a subframe determining section 104.

The transmitting/receiving section 101 performs transmission and reception of radio signals with the macro terminal UE. Specifically, the transmitting/receiving section 101 performs predetermined transmission processing on CRSs, time references and other data to generate transmission signals and transmits these transmission signals to the macro UE.

The setting section 102 sets a shift amount in a neighbor base station NeNB1 (pico base station or femto base station). The setting section 102 outputs the set shift amount to the X2 interface section 103.

The X2 interface section 103 performs transmission and reception of signals with a neighbor base station NeNB1 (pico base station or femto base station) via an X2 interface. Specifically, the X2 interface section 103 transmits the shift amount received as input from the setting section 102 to the neighbor base station NeNB1 (pico base station or femto base station).

The subframe determining section 104 determines a measurement subframe pattern including transmission stopped subframes. Note that the measurement subframe pattern is a measurement subframe pattern as illustrated in FIG. 3A, 3B, 5A or 5B. And, the subframe determining section 104 generates a time reference indicating a pattern start timing of the measurement subframe pattern. For example, in the case of the network configuration where a macro cell overlays a pico cell, the subframe determining section 104 determines the measurement subframe pattern and the time reference in accordance with the first or second method of the embodiment 1. In the case of the network configuration where a macro cell overlays a femto cell, the subframe determining section 104 determines the measurement subframe pattern and the time reference in accordance with the first or second method of the embodiment 2. The subframe determining section 104 outputs the measurement subframe pattern and the time reference to the transmitting/receiving section 101.

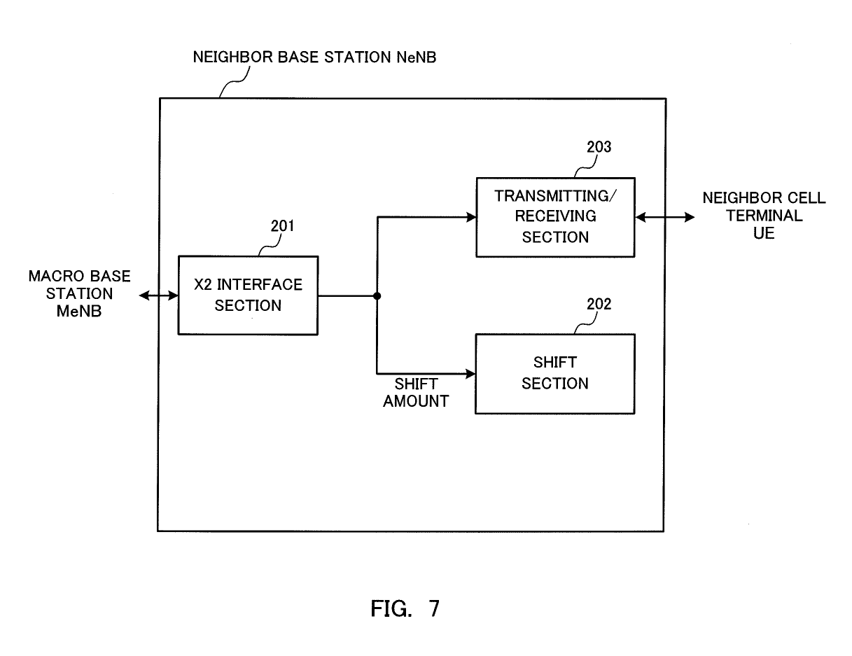

FIG. 7 is a diagram illustrating the functional structure of a neighbor base station (pico base station or femto base station) NeNB1 according to an embodiment of the present invention. As illustrated in FIG. 7, the neighbor base station NeNB has an X2 interface section (receiving section) 201, a shift section 202 and a transmitting/receiving section 203.

The X2 interface section 201 performs transmission and reception of signals (shift amounts) with the macro base station MeNB by an X2 interface.

The shift section 202 shifts subframes based on a shift amount communicated from the macro base station MeNB.

The transmitting/receiving section 203 performs transmission and reception of radio signals with a neighbor-cell user terminal UE. Specifically, the transmitting/receiving section 203 performs predetermined transmission processing on various data to generate transmission signals and transmits the transmission signals to the neighbor-cell user terminal UE.

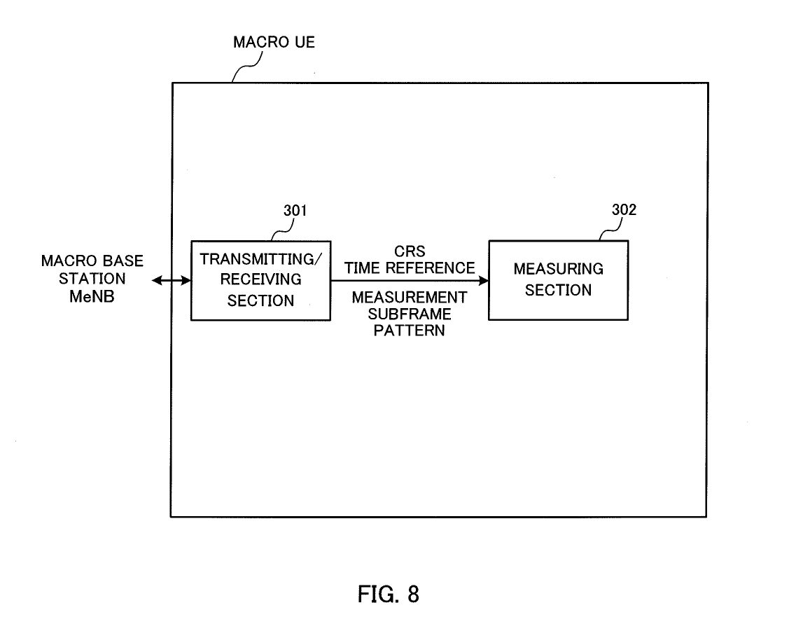

FIG. 8 is a diagram illustrating the functional structure of the macro UE according to an embodiment of the present invention. As illustrated in FIG. 8, the macro UE has a transmitting/receiving section (receiving section) 301 and a measuring section 302.

The transmitting/receiving section 301 performs transmission and reception of radio signals with the macro base station MeNB. Specifically, the transmitting/receiving section 301 receives signals including a measurement subframe pattern, a CRS, a time reference and other data. And, the transmitting/receiving section 301 outputs the measurement subframe pattern, the CRS and the time reference to the measurement section 302.

The measurement section 302 measures a channel state with use of the CRS received by the transmitting/receiving section 301. In this case, the measuring section 302 determines a measurement timing based on the measurement subframe pattern and the time reference and measures the channel state with use of the CRS at this measurement timing.

In the thus-structured radio communication system, in the case of the network configuration where a macro cell overlays a pico cell, the measurement subframe for CRS measurement is determined by the macro base station MeNB. Then, the subframe determining section 104 of the macro base station MeNB determines a measurement subframe pattern for CRS measurement in accordance with the network configuration information. In other words, the subframe determining section 104 determines the measurement subframe pattern illustrated in FIGS. 3A and 3B, considering that the macro base station MeNB becomes interference. This measurement subframe pattern and the time reference that is information of the pattern start timing of the measurement subframe pattern are communicated to the macro UE. The macro UE determines a measurement timing based on the measurement subframe pattern and the time reference and measures a CRS at this measurement timing.

On the other hand, in the case of the network configuration where a macro cell overlays a femto cell, a measurement subframe for CRS measurement is determined by the macro base station MeNB. Then, the subframe determining section 104 of the macro base station MeNB determines the measurement subframe for CRS measurement based on the network configuration information. In other words, the subframe determining section 104 determines the measurement subframe pattern as illustrated in FIGS. 5A and 5B, considering that the femto base station NeNB1 becomes interference. This measurement subframe pattern and the time reference that is information of the pattern start timing of the measurement subframe pattern are communicated to the macro UE. The macro UE determines a measurement timing based on the measurement subframe pattern and the time reference and measures a CRS at this measurement timing.

In the above-described embodiments 1 and 2, it is assumed that the macro base station determines a subframe pattern, and the macro UE determines a measurement timing based on the measurement subframe pattern and time reference and measures a CRS at this measurement timing. However, this is by no means intended to limit the present invention. The macro base station may be another radio base station or the macro UE may be another user terminal.

The present invention can be embodied in various modified or altered forms without departing from the sprit or scope of the present invention defined by claims. Accordingly, the description is given only for illustrative purposes and is by no means intended to limit the present invention. For example, the subframe numbers in the above-mentioned embodiments 1 and 2 are given only for illustrative purposes and may be changed to other numbers without limiting the present invention.

The disclosure of Japanese Patent Application No. 2010-255304, filed on Nov. 15, 2010, including the specification, drawings, and abstract, is incorporated herein by reference in its entirety.

1. A radio base station in a heterogeneous network having a network configuration where a macro cell overlays a micro cell that is smaller than the macro cell, the radio base station comprising:
a subframe determining section configured to generate a measurement subframe pattern to measure a channel state and a time reference indicating a pattern start timing of the measurement subframe pattern based on the network configuration; and
a transmitting section configured to transmit a signal including the measurement subframe pattern and the time reference to a user terminal.

2. The radio base station of claim 1, wherein the time reference indicates to match the pattern start timing with a radio frame timing of the radio base station having transmitted the measurement subframe pattern.

3. The radio base station of claim 1, wherein the time reference indicates to match the pattern start timing with a radio frame timing of a cell as a measurement target.

4. The radio base station of claim 3, wherein the micro cell is an OSG cell.

5. The radio base station of claim 2, wherein the micro cell is an CSG cell.

6. A user terminal in a heterogeneous network having a network configuration where a macro cell overlays a micro cell that is smaller than the macro cell, the user terminal comprising:
a receiving section configured to receive a measurement subframe pattern to measure a channel state; and
a measuring section configured to measure the channel state in accordance with the measurement subframe pattern and a time reference indicating a pattern start timing.

7. The user terminal of claim 6, wherein the time reference is transmitted from a radio base station.

8. The user terminal of claim 6, wherein the time reference is determined in advance.

9. The user terminal of claim 6, wherein the time reference indicates to match the pattern start timing with a radio frame timing of a radio base station having transmitted the measurement subframe pattern.

10. The user terminal of claim 6, wherein the time reference indicates to match the pattern start timing with a radio frame timing of a cell as a measurement target.

11. A radio communication method comprising the steps of:
a radio base station in a heterogeneous network having a network configuration where a macro cell overlays a micro cell that is smaller than the macro cell,
generating a measurement subframe pattern to measure a channel state and a time reference indicating a pattern start timing of the measurement subframe pattern based on the network configuration; and
transmitting a signal including the measurement subframe pattern and the time reference to a user terminal; and
the user terminal
receiving the signal including the measurement subframe pattern and the time reference; and
measuring the channel state based on the measurement subframe pattern and the time reference.

12. A radio communication method comprising the steps of:
a radio base station in a heterogeneous network having a network configuration where a macro cell overlays a micro cell that is smaller than the macro cell, the radio base station:
generating a measurement subframe pattern to measure a channel state based on the network configuration, and
transmitting a signal including the measurement subframe pattern to a user terminal; and
the user terminal:
receiving the signal including the measurement subframe pattern, and
measuring the channel state based on the measurement subframe pattern and a time reference indicating a pattern start timing of the measurement subframe pattern.

13. The user terminal of claim 7, wherein the time reference indicates to match the pattern start timing with a radio frame timing of a radio base station having transmitted the measurement subframe pattern.

14. The user terminal of claim 7, wherein the time reference indicates to match the pattern start timing with a radio frame timing of a cell as a measurement target.

15. The user terminal of claim 8, wherein the time reference indicates to match the pattern start timing with a radio frame timing of a radio base station having transmitted the measurement subframe pattern.

16. The user terminal of claim 8, wherein the time reference indicates to match the pattern start timing with a radio frame timing of a cell as a measurement target.
